(19) United States
(12) Patent Application Publication
(10) Pub. No.: US 2013/0025408 A1
(43) Pub. Date: Jan. 31, 2013

(54) INDEXING OF A MACHINE TOOL TURRET

(71) Applicant: Marco Vettori, Loveresse (CH)

(72) Inventor: Marco Vettori, Loveresse (CH)

(73) Assignee: TORNOS SA, Moutier (CH)

(21) Appl. No.: 13/641,377

(22) PCT Filed: Apr. 24, 2011
(86) PCT No.: PCT/EP11/56443

§ 371 Date: Oct. 15, 2012

(30) Foreign Application Priority Data
Apr. 26, 2010 (EP) 10161024.4

(51) Int. Cl. B23Q 16/02

(52) U.S. Cl. 74/813 C; 74/813 L

(57) ABSTRACT

The present invention relates to a system for indexing a turret of a multi-spindle machine tool. The system includes: a turret designed to rotate about an axis; and a turret drive mechanism. The drive mechanism is designed to index the turret in order to position the turret angularly in a free manner while rotating about said axis, and the drive mechanism is designed to lock the turret in this position.

### FIELD OF THE INVENTION

The invention relates to a system for indexing a turret of a machine tool. The invention likewise relates to a machine tool comprising this indexing system.

### DESCRIPTION OF THE PRIOR ART

Machine tools, such as automatic lathes, are known comprising multiple spindles for receiving the material to be machined. This is generally in the form of a bar or blanks. The spindles are generally designed to rotate with the material to be machined about an axis.

The spindles are generally situated at least partially in a turret which is thus around these spindles. In certain solutions, a turret contains six spindles, each spindle being separated angularly by 60 degrees. A machine tool having such a turret can likewise comprise six work stations. Each work station is equipped with one or more tools for machining the material held by the spindles. To make the machining operation more efficient, each work station can machine simultaneously the material held by a spindle.

Often in the known solutions the indexing of the turret is not carried out in an optimal way. Understood by indexing is the operation of positioning the turret in a desired angular place. Many known solutions have a rather complex turret driving mechanism, and this drive mechanism does not allow the positioning of the turret in certain defined positions. In the case of the turret having six spindles, these positions are thus separated angularly by 60 degrees.

Moreover, the known solutions often have a rather complex turret locking/unlocking mechanism. This mechanism is often independent of the drive system, which renders the machine tool unnecessarily complex.

### SUMMARY OF THE INVENTION

The object of the present invention is to overcome the problems of the known solutions. The present invention thus proposes a solution for the indexing and/or the locking/unlocking of a turret of a machine tool as explained in more detail further below.

To this end, the invention has as subject matter a system for indexing a turret of a multi-spindle machine tool, the system comprising:

a turret designed to rotate about an axis; and

a turret drive mechanism,

characterized in that the drive mechanism is designed to index the turret in order to position the turret angularly in a free manner while rotating about said axis, and in that the drive mechanism is designed to lock the turret in this position.

Use of this type of system for a machine tool makes it possible to reduce the number of mechanical parts of the machine, and thus to lower the costs. This also means that the time for mounting of the turret frame element is decreased through reduction of the number of parts. The proposed solution also makes it possible to use a previously non-productive machine axis as a work axis without increasing the cost price of the machine.

The solution also makes it possible to increase considerably the precision or the capacity of the machine on a given spindle or at a given station without having to make the product more expensive and to increase the precision or the overall capacity of the machine without having to improve the precision of the different components which constitute it. Moreover the proposed system allows production of pieces of high complexity, requiring a large number of tools, without having to resort to a machine having more spindles or slides.

The invention also has as subject matter a machine tool comprising the indexing system.

The other aspects of the present invention are found in the dependent claims.

### BRIEF DESCRIPTION OF THE DRAWINGS

The invention will be well understood from reading the description which follows, given by way of non-limiting example, with reference to the attached drawings, which represent schematically:

FIG. 1: in perspective and partial section, a turret drive system according to one embodiment of the present invention,

FIG. 2: in perspective, a turret drive mechanism according to one embodiment of the present invention, and

FIG. 3: in perspective and partial section, a turret drive system with a housing according to one embodiment of the present invention.

### DETAILED DESCRIPTION OF ONE EMBODIMENT

Referring to the drawings, a non-limiting embodiment of a turret drive mechanism of a multi-spindle machine tool according to the present invention is now explained in more detail.

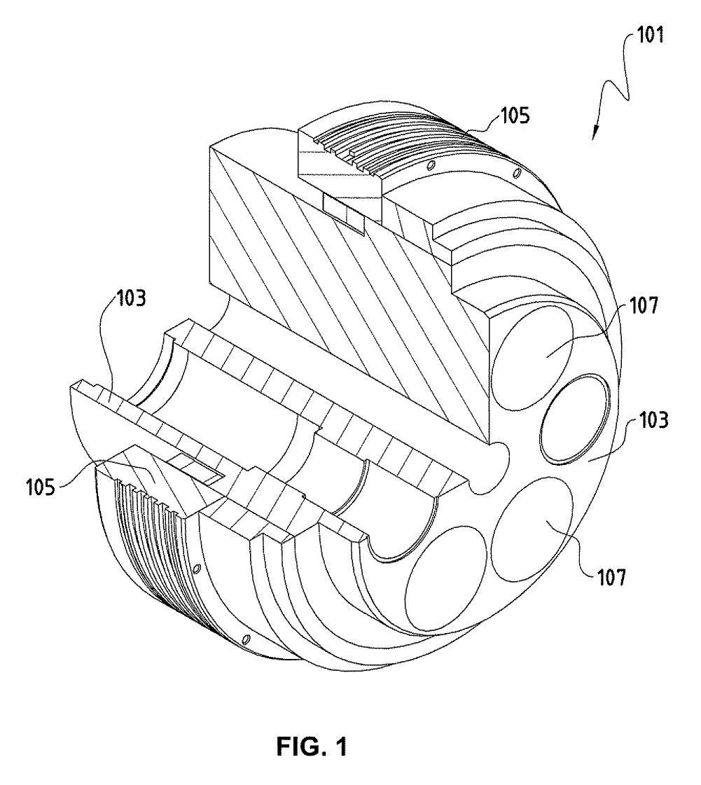

FIG. 1 represents a view in perspective and partial section of a turret 103 driving or indexing system 101 of a machine tool for indexing the turret 103. The machine tool also comprises at least one tool system (not illustrated in the figures) comprising work stations or machining unit, the number of which can be equal to, greater than or less than the number of spindles in the turret 103. A tool system is a functional subunit used to achieve the machining operations on a piece held by the spindle of the machine tool.

The tool system, on the one hand, is equipped with a plurality of machining tools which are intended to be guided and displaced in different predetermined planes to allow complex machining of the piece, and, on the other hand, is placed under the influence of at least one, for example numerical, control unit.

In this example, the drive mechanism 105 is a torque motor which is thus used instead of a traditional mechanical indexing system of a multi-spindle machine tool turret. Also seen in FIG. 1 are holes 107 for receiving the spindles (not illustrated in the figures) which are designed to hold the pieces to be machined. To ensure their operation, the spindles are normally driven in rotation about a predetermined axis to make the pieces to be machined turn. The drive mechanism for the spindles is independent of the torque motor 105 of the turret 103. The turret 103 illustrated in FIG. 1 is designed to receive six spindles.

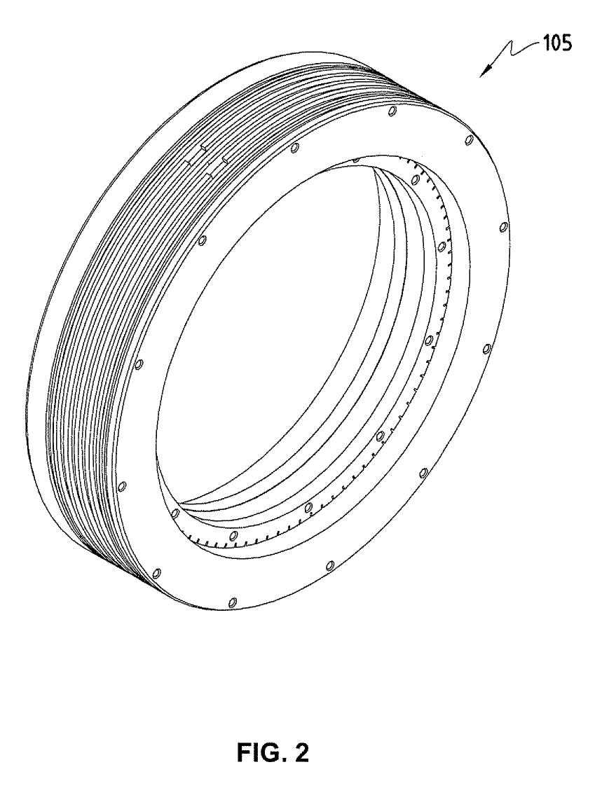

The torque motor 105, also illustrated in FIG. 2, is thus located around the turret 103, and can be considered integrated therewith.

Torque motors are a special category of brushless permanent-magnet servomotors commonly referred to as brushless d.c. motors or permanent magnet synchronous motors. The load is directly mounted on the rotor without intermediary transmission elements. Torque motors are thus classified as a solution for direct drive.

Direct coupling of the load on the rotor eliminates the need for transmission elements such as drive belts, gears, reduction gears, worm gears, maltese crosses or manifolds. Unlike motors with brushes, there is no contact with the pieces in movement in a direct drive system. There is thus no mechanical wear and tear, which means an excellent reliability and a long service life. The reduction in the number of mechanical components thus minimizes the maintenance and reduces the cost of the system. The torque-motor-based direct drive technology itself ensures a cost-effective and efficient assembly.

Depending upon the point of view, a torque motor is either a conventional servomotor with a large number of poles or a rolled-up linear motor. Owing to this large number of poles, torque motors are able to attain high torque at moderate speeds. The design of a torque motor is compact with narrow lamination stack and a large hollow shaft. Torque motors are “frameless” motors. This means that they they do not have bearings, housing or signal feedback device.

Torque motors produce high torque at moderate speed or when the motor is stopped. Contrary to conventional drives, the sizing of a torque motor is based purely on torque (and not on power). The peak torque determines the maximum torque that the motor can physically produce.

According to this embodiment of the present invention, the torque motor 105 is used instead of a mechanical indexing system for a multi-spindle machine turret. As the torque motor 105 according to the present invention can also be used as a mechanism of locking/unlocking of the turret 103, this torque motor 105 can thus be used instead of a conventional locking system for a multi-spindle machine turret. Consequently, the torque motor 105 according to the present invention can be used instead of an indexing system and a locking system for a multi-spindle machine turret. This torque motor can replace these two mechanisms in an advantageous way.

This torque motor 105 also makes it possible to achieve a supplementary work axis on a multi-spindle type machine owing to the fact of being able to position the turret 103 in any angular position. The torque motor 105 likewise allows the precise angular positioning of any spindle on a precise work station. This station thus becomes a station of precision because the error in the position of any spindle on this specific station can be eliminated.

The torque motor 105 also allows the precise angular positioning of a predefined spindle on any station. This spindle thus becomes a spindle of precision because the error can be eliminated in the position of this specific spindle on any station.

It is also possible to measure at a specific position of the turret 103 the error of positioning of at least two spindles with respect to the corresponding work station and to calculate an average error. This average error can be used according to the present invention to allow the average angular positioning of any spindle on any station.

Use of the torque motor 105 likewise allows the multiplication of work stations independently of the number of spindles. That is to say the angle (or angles) of indexing of the turret can be chosen to be greater or less with respect to fixed stations. For example, a solution can be envisaged comprising six spindles and 12 work stations. In this case here, six work stations work simultaneously and six work stations are stopped. The tools of the six work stations can be replaced at the same time as the six other work stations are in the course of machining. In this case here, the turret can be indexed 30 degrees with respect to the preceding position.

The torque motor 105 can also be be designed to index simultaneously with the turret, a feeder or a bar guide of a machine tool. It is also possible for the torque motor 105 to be controlled synchronously with an identical drive system mounted on a feeder or a bar guide.

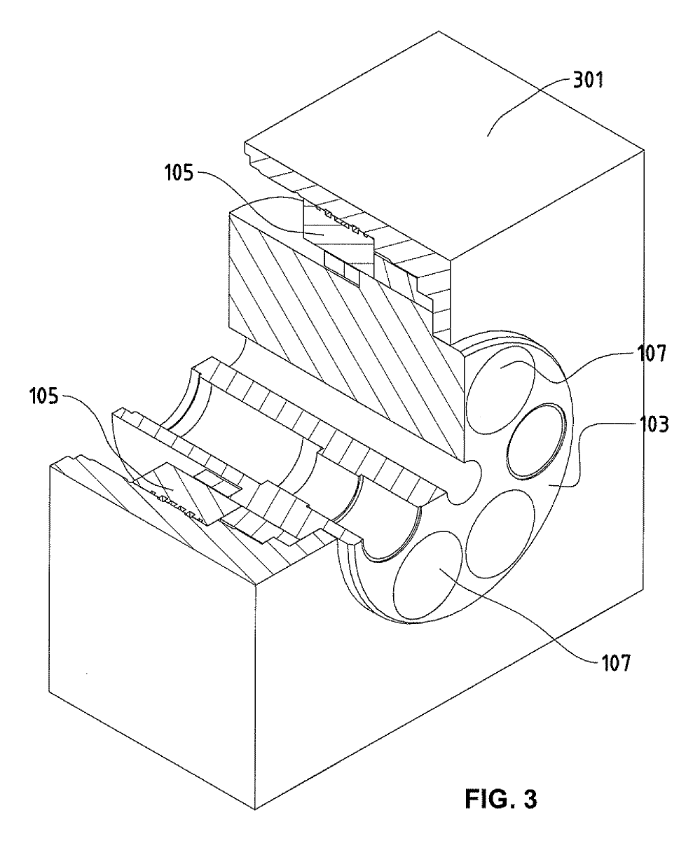

The indexing system 101 illustrated in FIG. 1 can be seen placed in a housing 301 in FIG. 3. The aim of this housing 301 is to protect the indexing system 101.

The solution described above has multiple applications in machine tools. For example, the solution can be used on a multi-spindle automatic lathe to achieve the operations described above.

Numerous variations can also be envisaged in the configuration explained above without departing from the framework of the present invention.

1. A system for indexing a turret of a multi-spindle machine tool, the system comprising:
a turret designed to rotate about an axis, the turret comprising holes for receiving spindles; and
a turret drive mechanism,
wherein the drive mechanism is designed to index the turret in order to position the turret angularly in any angular position while rotating about said axis, wherein the drive mechanism is designed to lock the turret in this position, and the drive mechanism is located around the turret, and wherein the drive mechanism is a torque motor.

2. The system according to claim 1, in which the drive mechanism is integrated in the turret.

3. The system according to claim 1, in which the drive mechanism is designed to index simultaneously with the turret a feeder or a bar guide.

4. The system according to claim 1, in which the drive mechanism is controlled synchronously together with an identical drive system mounted on a feeder or a bar guide.

5. The system according to claim 1, in
which the locking is carried out by the drive mechanism without using a supplementary locking system.

6. A machine tool comprising the system according to claim 1.

7. The machine tool according to claim 6, in which the machine tool comprises work stations for machining a piece, the number of work stations being more than the number of spindles.

8. The machine tool according to claim 6, in which the machine tool comprises work stations for machining a piece, the number of work stations being fewer than the number of spindles.

9. The machine tool according to claim 6, wherein the drive mechanism without a supplementary locking system is designed to lock the turret in said position.

10. A method of indexing of a turret of a multi-spindle machine tool comprising an indexing system comprising: a turret designed to turn about an axis, the turret comprising holes for receiving spindles; and a drive mechanism of the turret, the method comprising:
the indexing, by the drive mechanism, of the turret for positioning angularly the turret in any angular position while turning about said axis,
the locking, by the drive mechanism, of the turret in this position, the drive mechanism being located around the turret, and wherein the drive mechanism is a torque motor.

11. The method according to claim 10, further comprising, in a specific position of the turret, the calculation of an individual error of positioning for at least two spindles in relation to a corresponding work station, and the turret being then indexed using the average error obtained from these individual errors.

12. The method according to claim 10, further comprising, in each specific position of the turret, the correction of an individual error of positioning for a spindle in relation to each of the corresponding work stations, and the turret being then indexed using the calculated or measured correction.

13. The method according to claim 10, further comprising, in a specific position of the turret, the correction of an error in positioning for each spindle in relation to an individual work station, and the turret being then indexed using the calculated or measured correction.
